(19) United States
(12) Patent Application Publication
(10) Pub. No.: US 2011/0010754 A1
(43) Pub. Date: Jan. 13, 2011

(54) ACCESS CONTROL SYSTEM, ACCESS CONTROL METHOD, AND RECORDING MEDIUM

(76) Inventor: Yoichiro Morita, Tokyo (JP)

Correspondence Address: Mr. Jackson Chen, 6535 N. STATE HWY 161, IRVING, TX, 75039, US

(21) Appl. No.: 12/920,196

(22) PCT Filed: Mar. 9, 2009
(86) PCT No.: PCT/JP2009/054403

§ 371 Date: Aug. 30, 2010

(30) Foreign Application Priority Data
Mar. 10, 2008 (JP) 2008 060231
Sep. 17, 2008 (JP) 2008 238663

(51) Int. Cl. G06F 21/00

(52) U.S. Cl. 726/1

(57) ABSTRACT

When access control implementing sections of many types different depending on an object are connected simultaneously, an access control list applied to each of the access control implementing sections is generated in a format corresponding to each access control implementing section, and a process of transferring to each access control implementing section is collectively executed based on an access control policy. Specifically, the access control lists different every access control implementing section are generated from a same access control policy based on a relation between an object and an access control implementing section for the access control implementing sections. A setting file in a format different every access control implementing section is generated from the access control list described in a format which does not depend on a kind of the access control implementing section, based on a relation of a format template of the setting file describing contents of the access control list and the access control implementing section. The setting file is distributed based on a relation of a distribution destination of the setting file and the access control implementing section.

### TECHNICAL FIELD

The present invention relates to an access control system, and more particularly relates to an access control system in which objects different in an action available to the object are mixedly present.

### BACKGROUND ART

One example of an access control method is described in Japanese Patent Publication (JP-A-Heisei 11-313102A). The access control method described in this publication is a method of generating an access control list, which is described based on an access subjective entity and an access target, from an access control policy described in accordance with constraints based on an access subjective entity type, an access target type and an organization structure. The access control method described in the above Publication makes it possible to generate only the access control list that satisfies constraints by using the following data, by providing a subjective entity type group data that directly relates a subjective entity (access subjective entity) and a subjective entity type, a target type group data that directly relates a target (access target) and a target type, and an organization structure data in which the relation between the subjective entity, the target and the organization is represented by a single tree structure.

However, in the access control method described in the above Publication, there is a problem that the generation and distribution of the access control list for the object cannot be collectively performed in accordance with description of the access control policy when the objects different in action available thereto are mixedly present and an access control implementing sections (access control unit) of distribution destinations of the access control lists are different depending on the object. This is because in the access control method described in the above Publication there is no method of specifying an action available to an object and an access control implementing section to which the access control list is distributed.

Also, as a related technique, Japanese Patent Publication (JP 2002-202888A) discloses a rule base system and an information providing method. In this related technique, an information collecting apparatus inputs a new data into a database and an information processing apparatus. A rule detecting section detects a rule, which has the new data as one of conditions, from a condition tree, and reads a condition data of the detected rule from a condition storage section and an action data from an action storage section. An information detecting section detects a data adaptive for each of the condition data of the rule detected by the rule detector, from a database. A rule display unit displays the action data of the rule when the information detecting section satisfies all of the conditions of the rule, and displays the action data of the rule and the condition data that is not satisfied, when there is the condition data that is not satisfied.

Also, Japanese Patent Publication (JP 2006-012117A) discloses an access control system, an access control method and an access control program. In this related technique, a policy storing unit stores an access control policy which is a set of setting data so that resources (access destinations) are shared by ad-hoc groups. When a part of the access control policy is edited, a policy analyzing section updates a rule generated from the edited access control policy. At this time, a user updates the rule by using object knowledge having a data structure which can be represented to belong to a plurality of user groups. An access control list setting section updates a part of the access control list in accordance with the updated rule.

### DISCLOSURE OF THE INVENTION

An object of the present invention is to provide an access control system, an access control method, an access control program and a recording medium, in which, when objects having different available actions are mixedly present and an access control implementing section (access controlling section) of a distribution destination of an access control list is different depending on the object, the generation and distribution of the access control list for the objects can be collectively performed in accordance with the description content of an access control policy.

The access control system of the present invention contains: a plurality of access control implementing sections configured to control access to objects; a system configuration managing section configured to store data associated with a relation between an object group and an object, a relation between the object and an action, a relation between the object and each of the plurality of access control implementing sections, and a relation between the access control implementing section and an installation location of a setting file of the access control implementing section, and retrieve the data associated with a requested relation to output a search result; and a policy engine configured to refer to the system configuration managing section to generate an access control policy describing a data of a set of the object group and the action, and generate an access control list, which is different every the access control implementing section, from the access control policy for the plurality of access control implementing sections.

The access control method of the present invention includes: controlling access to objects by a plurality of access control implementing sections; storing data associated with a relation between an object group and an object, a relation between the object and an action, a relation between the object and each of the plurality of access control implementing sections, and a relation between the access control implementing section and an installation location of a setting file of the access control implementing section, and retrieving the data associated with a requested relation to output a search result; and referring to the system configuration managing section to generate an access control policy describing a data of a set of the object group and the action, and generating an access control list, which is different every the access control implementing section, from the access control policy for the plurality of access control implementing sections.

The access control program of the present invention is a program to make a computer to execute: controlling access to objects by a plurality of access control implementing sections; storing data associated with a relation between an object group and an object, a relation between the object and an action, a relation between the object and each of the plurality of access control implementing sections, and a relation between the access control implementing section and an installation location of a setting file of the access control implementing section, and retrieving the data associated with a requested relation to output a search result; and referring to the system configuration managing section to generate an access control policy describing a data of a set of the object group and the action, and generating an access control list, which is different every the access control implementing section, from the access control policy for the plurality of access control implementing sections.

The recording medium according to the present invention is a recording medium in which the access control program is stored in order to make a computer to execute: controlling access to objects by a plurality of access control implementing sections; storing data associated with a relation between an object group and an object, a relation between the object and an action, a relation between the object and each of the plurality of access control implementing sections, and a relation between the access control implementing section and an installation location of a setting file of the access control implementing section, and retrieving the data associated with a requested relation to output a search result; and referring to the system configuration managing section to generate an access control policy describing a data of a set of the object group and the action, and generating an access control list, which is different every the access control implementing section, from the access control policy for the plurality of access control implementing sections.

Even if objects in which combinations with actions are different, such as Operating Systems in which file systems are different are mixedly present, and access control implementing sections of many types are connected at a same time, the access control policy can be described without any awareness of the above states, by a same method and system as the conventional method and system and the access control can be collectively executed.

### BRIEF DESCRIPTION OF THE DRAWINGS

FIG. 1 is a block diagram showing a system configuration of an access control system according to the present invention;

FIG. 2 is a flowchart showing an operation of the access control system;

FIG. 3 is a flowchart showing an operation of a policy editing section;

FIG. 4 is a diagram showing an example of a UI (User Interface) for inputting a subject and selecting an action, which UI is generated by the policy editing section;

FIG. 5 is a diagram showing a relation between an object group and an object and a relation between an object and an object type, which are stored in a system configuration managing section;

FIG. 6 is a diagram showing an example of a UI for selecting the object group, which is generated by the policy editing section;

FIG. 7 is a diagram showing an example of a relation between the object type and an action, which is stored in the system configuration managing section;

FIG. 8 is a diagram showing an example of an access control policy generated by the policy editing section;

FIG. 9 is a flowchart showing an operation of a policy interpreting section;

FIG. 10 is a diagram showing an example of a relation between an object and an access control implementing section, which is stored in the system configuration managing section;

FIG. 11 is a diagram showing an example of an ACL generated by the policy interpreting section;

FIG. 12 is a diagram showing an example of the ACL generated by the policy interpreting section;

FIG. 13 is a diagram showing an example of the ACL generated by the policy interpreting section;

FIG. 14 is a flowchart showing an operation of a format converting section;

FIG. 15 is a diagram showing an example of a relation between an access control implementing section and a template, which is stored in the system configuration managing section;

FIG. 16 is a diagram showing an example of a template stored in a format managing section;

FIG. 17 is a diagram showing an example of a template stored in the format managing section;

FIG. 18 is a diagram showing an example of a setting file generated by the format converting section;

FIG. 19 is a diagram showing an example of a setting file generated by the format converting section;

FIG. 20 is a diagram showing an example of a setting file generated by the format converting section; and

FIG. 21 is a diagram showing an example of a relation between the access control implementing section and an output destination of the setting file of the access control implementing section, which is stored in the system configuration managing section.

### BEST MODE FOR CARRYING OUT THE INVENTION

An access control system of the present invention will be described below with reference to the attached drawings.

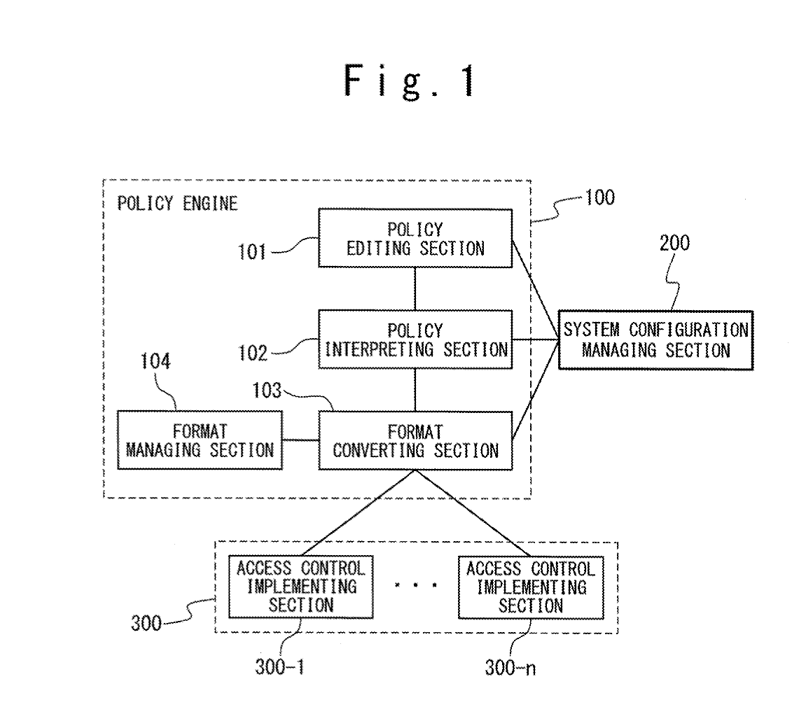

As shown in FIG. 1, an access control system according to an embodiment of the present invention contains a policy engine 100, a system configuration managing section 200 and an access controlling section 300 containing access control implementing sections 300-i (i=1 to n: n is optional).

The access control system is realized by a computer system. It should be noted that the policy engine 100, the system configuration managing section 200 and the access controlling section 300 may be respectively realized as different computer systems. Or, the policy engine 100, the system configuration managing section 200 and the access controlling section 300 may be partially or entirely realized by a same computer system. For example, the policy engine 100, the system configuration managing section 200 and the access controlling section 300 may be realized by different virtual machines (VMs) on a same computer system. However, the present invention is not limited to those examples.

The policy engine 100 includes a policy editing section 101, a policy interpreting section 102, a format converting section 103 and a format managing section 104. Specifically, each of the policy editing section 101 and the policy interpreting section 102 is attained by a CPU (Central Processing Unit) of an information processing apparatus operating in accordance with a program, a storage medium such as RAM (Random Access Memory), and a communication interface (I/F) to communicate with the system configuration managing section 200.

Also, specifically, the format converting section 103 is attained by the CPU in the information processing apparatus operating in accordance with the program, the storage medium such as the RAM, and a communication interface to communicate with the format managing section 104, the system configuration managing section 200 and the access controlling section 300.

Moreover, specifically, the format managing section 104, the system configuration managing section 200 and the access controlling section 300 are attained by the CPU in the information processing apparatus operating in accordance with the program, and the storage medium such as the RAM and a hard disc.

However, the present invention is not limited to those examples.

The policy editing section 101 provides a UI (User Interface) for editing a policy while retrieving a list of object groups and actions corresponding to the object groups from the system configuration managing section 200.

The policy interpreting section 102 obtains the policy supplied from the policy editing section 101, and retrieves objects corresponding to an object group and the access control implementing sections 300-i (i=1 to n) corresponding to the objects from the system configuration managing section 200, and generates an access control list (ACL) for each access control implementing section 300-i (i=1 to n). Here, the policy interpreting section 102 generates the access control list (ACL) from the access control policy that describes a set of the object group and the actions at least.

The format converting section 103 obtains the ACL for each access control implementing section 300-i (i=1 to n) supplied from the policy interpreting section 102, retrieves templates corresponding to the access control implementing sections 300-i (i=1 to n) from the format managing section.104, generates a setting file of each access control implementing section 300-i (i=1 to n) based on the retrieved template, and retrieves data of output destinations of the setting files of the access control implementing sections 300-i (i=1 to n) from the system configuration managing section 200 and then outputs the setting files to the output destinations.

The format managing section 104 stores the template for each access control implementing section 300-i (i=1 to n) and outputs the template for the requested access control implementing section 300-i (i=1 to n). Here, the format managing section 104 stores format templates and a format template correspondence table. The format template correspondence table indicates a relation between the access control implementing section 300-i (i=1 to n) and the format template of the setting file of the access control implementing section 300-i (i=1 to n).

The system configuration managing section 200 stores data associated with a relation between a object group and objects, a relation between the object and an object type, a relation between the object type and actions, a relation between the object and the access control implementing section 300-i (i=1 to n) and a relation between the access control implementing section 300-i (i=1 to n) and an installation location of the setting file, and retrieves the data associated with a requested relation and then outputs the retrieval result. Here, the system configuration managing section 200 stores an object group correspondence table, an access control correspondence table and an action correspondence table at least. The object group correspondence table indicates the relation between the object group and one or more objects corresponding to the object group. The access control correspondence table indicates the relation between an object and an access control implementing section for controlling the access to the object. The action correspondence table indicates the relation between an object and an action available to the object.

The access control implementing section 300-i (i=1 to n) obtains the setting file supplied from the format converting section 103 and executes an access control in accordance with the ACL content described in the setting file.

Here, terms used in this embodiment will be described.
“Access Right”: implies a set of a specific subject (s), object (o) and action (a) in this embodiment.
“Access Control Rule” or “Rule”: describes one of the access rights.
“Access Control List” or “ACL”: is a list of the access control rules that do not depend on a type of the access control implementing section 300-i (i=1 to n).
“Object Type”: is an identifier indicating a type of object, and an action available to the object is determined based on the type of object. It should be noted that a relation between the object and the action is automatically determined by comparing a relation between the object and the object type and a relation between the object type and the action.
“Object Group”: is a name of a set of the objects and the object types of the objects included in the same object group are identical. It should be noted that a relation between the object group and the action is automatically determined by comparing a relation between the object group and the object, a relation between the object and the object type, and a relation between the object type and the action. As an example of the description content of the object group,
“System A Development Source File” is considered. Also, as an example of the description content of the object for the above object group, “host1.domain.jp/src/system-a.src” and “host2.domain.jp/var/src/systemA.src” are considered.
“Access Control Policy” or “Policy” is metaphysical representation of the access control data, which describes rules, equations and functions that derive the subject, object and action, which configure an ACL, and describes a list of sets of a subject, object group and action. As an example of the description content of the access control policy, a subject of “System A Development Contact Personnel”, an object group of “System A Development Source File”, and actions of
“Read permission”, “Write permission”, and “Execution permission” are considered.
“Setting File”: is a setting data of the access control implementing section 300-i (i=1 to n), including: the content of the ACL, and its format depends on the type of the access control implementing section 300 (300-i, i=1 to n).
“Template”: describes the rule, constant, fixed phrase and the like for the format conversion to convert the ACL into the setting file, and this is related to each access control implementing section 300-i (i=1 to n).

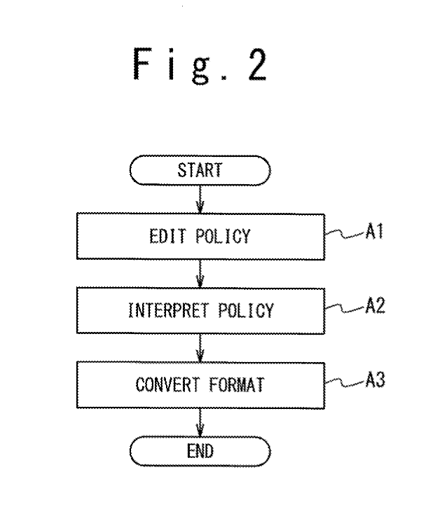

The processes in this embodiment will be described below with reference to FIG. 2.

### (1) Step A1

At first, the policy editing section 101 executes a policy editing process.

### (2) Step A2

Next, the policy interpreting section 102 executes a policy interpreting process.

### (3) Step A3

Next, the format converting section 103 executes a format converting process.

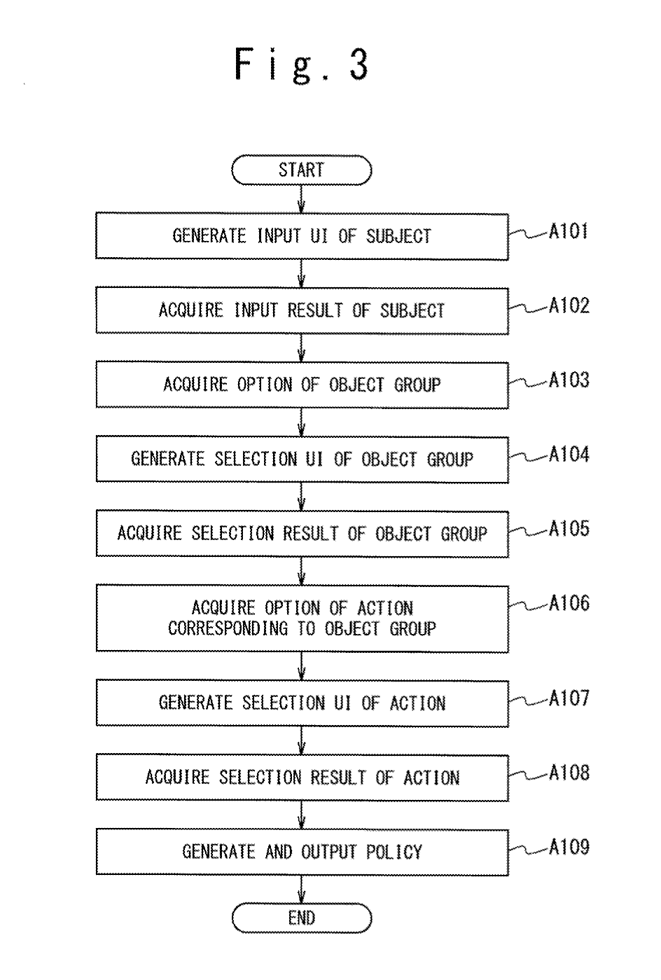

The operation in the policy editing process will be described below with reference to FIG. 3.

### (1) Step A101

At first, the policy editing section 101 generates a

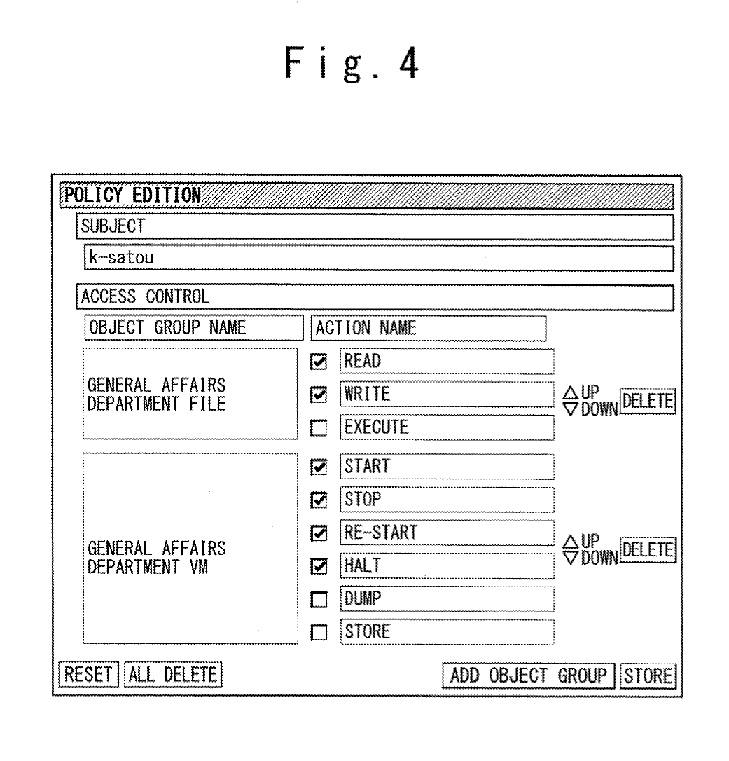

UI for inputting a subject and provides an input method to a user by displaying it. For example, the policy editing section 101 uses the UI shown in FIG. 4 and provides the input form of the subject to the user.

### (2) Step A102

Next, the policy editing section 101 obtains the input content executed by the user by using the generated UI. For example, the policy editing section 101 obtains an input content of “k-satou” into the UI shown in FIG. 4.

### (3) Step A103

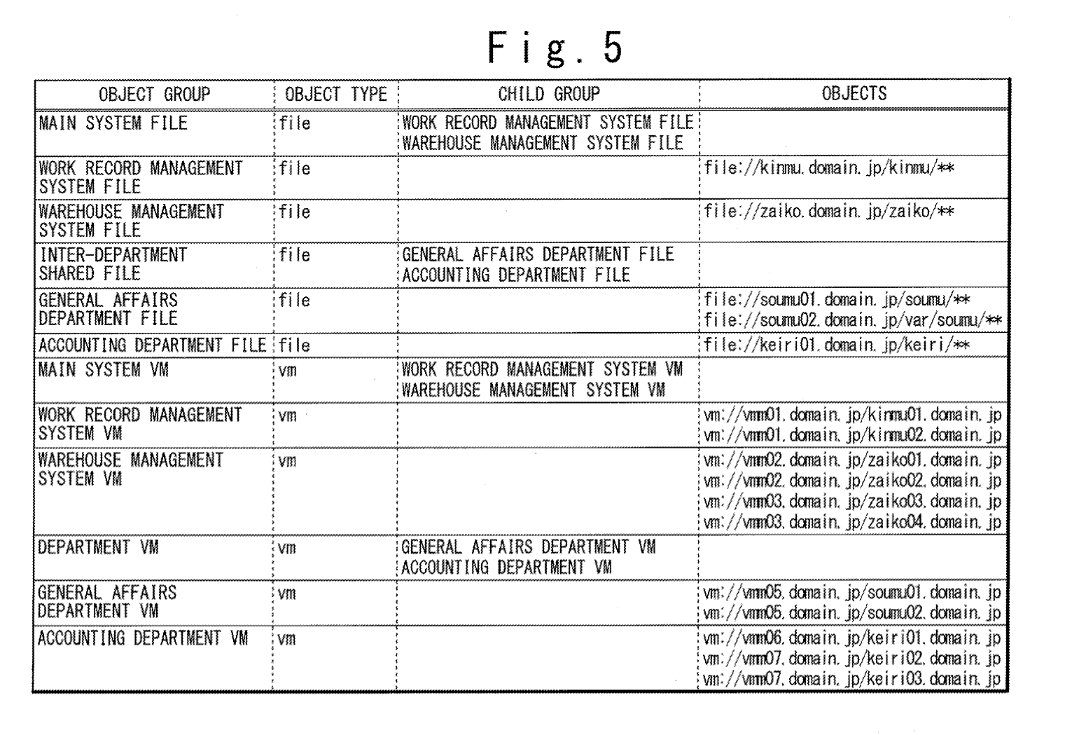

Next, the policy editing section 101 requests a list of object groups to the system configuration managing section 200 and obtains the list of object groups from the system configuration managing section 200. For example, the system configuration managing section 200 refers to data of object groups shown in FIG. 5 and returns the object groups of “Main System File”, “Work Record Management System File”, “Warehouse Management System File”, “Inter-Department Shared File”, “General Affairs Department File”, “Accounting department File”, “Main System VM”, “Work record Management System VM”, “Warehouse Management System VM”, “Department VM”, “General Affairs department VM” and “Accounting department VM”. Also, as shown in FIG. 5, an object group may have different object groups as child groups. When an object group has a child group, the system configuration managing section 200 firstly returns a list of only parent object groups of “Main System File”, “Inter-Department Shared File”, “Main System VM” and “Department VM” at the time of returning the list of object groups, and then when there is an additional request of obtaining a list of child groups, a procedure may separately return the list of object groups of the child groups.

### (4) Step A104

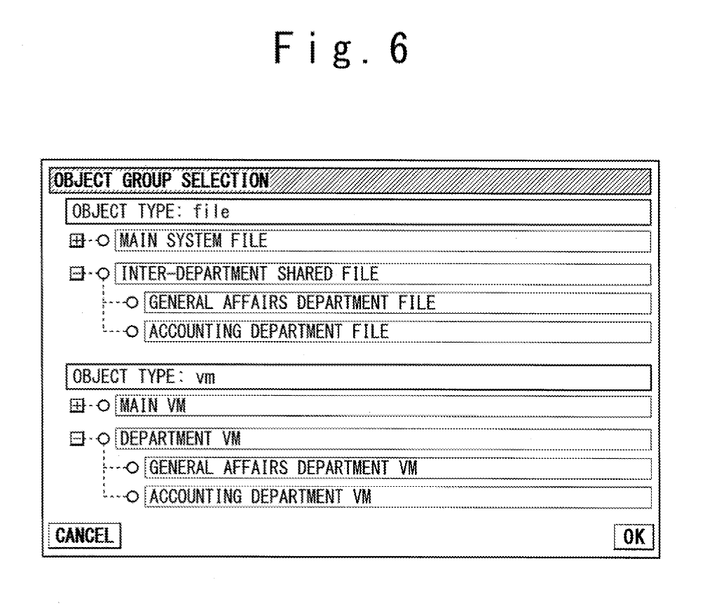

Next, the policy editing section 101 generates a UI for selecting an object group and provides a selecting method to the user by displaying it. For example, the policy editing section 101 provides an input form to select the object group to the user, by using a UI shown in FIG. 6.

### (5) Step A105

Next, the policy editing section 101 obtains a selection content inputted by the user by using the generated UI. For example, the policy editing section 101 obtains “General Affairs Department VM” as the selection content of the object group in the UI shown in FIG. 6.

### (6) Step A106

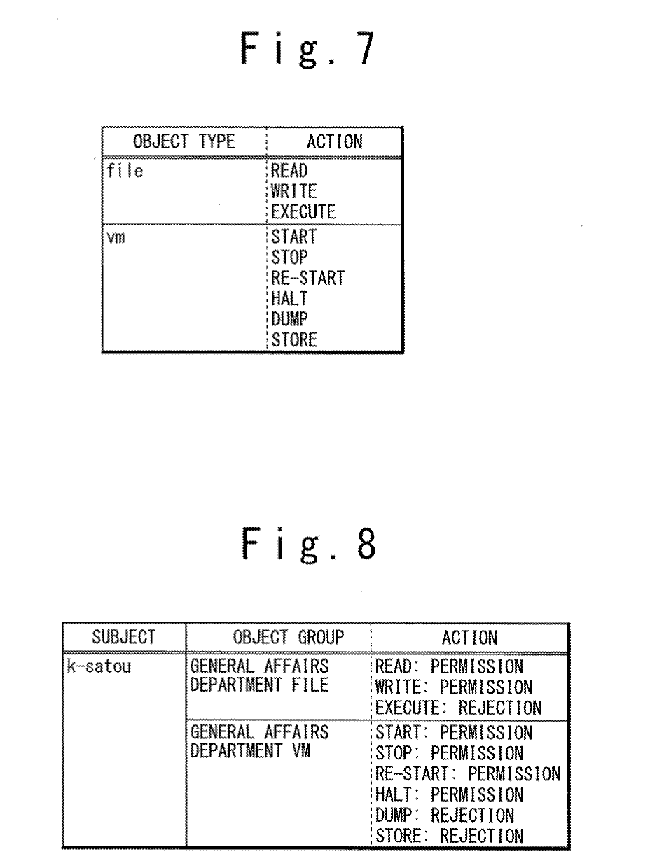

Next, the policy editing section 101 requests a list of actions corresponding to the object group selected by the user, to the system configuration managing section 200 and obtains the list of actions from the system configuration managing section 200. For example, the system configuration managing section 200 refers to the relation between an object group and objects as shown in FIG. 5, the relation between an object and an object type, and the relation between an object type and actions as shown in FIG. 7, and returns actions corresponding to the object group selected by the user. For example, the system configuration managing section 200 returns the actions of “Start”, “Stop”, “Re-start”, “Halt”, “Dump” and “Store” that correspond to the object group of “General Affairs Department VM”.

### (7) Step A107

Next, the policy editing section 101 generates a UI to select an action and provides a selecting method to the user by displaying it. For example, the policy editing section 101 uses the UI shown in FIG. 4 and provides the input form to select the action to the user.

### (8) Step A108

Next, the policy editing section 101 obtains a selection content inputted by the user by using the generated UI. For example, the policy editing section 101 obtains “Start Permission”, “Stop Permission”, “Re-start Permission”, “Halt Permission”, “Dump Rejection” and “Store Rejection” as the selection contents of the actions corresponding to the object group of “General Affairs Department VM” in the UI shown in FIG. 4. Here, the policy editing section 101 determines that action items are in “Permission”, in which a check is performed in a check box corresponding to each of the actions of “Start”, “Stop”, “Re-start”, “Pause”, “Dump” and “Store”, and action items re “Rejection”, in which the check is not performed, in the UI shown in FIG. 4. However, actually, the present invention is not limited to those examples.

### (9) Step A109

Next, the policy editing section 101 uses a set of values of the subject, the object group and the actions, which are inputted or selected by the user, to generate a policy and outputs it to the policy interpreting section 102. For example, the policy editing section 101 arranges the values, which are inputted into the input form for selection by the user, in accordance with a predetermined syntax, and generates a policy shown in FIG. 8.

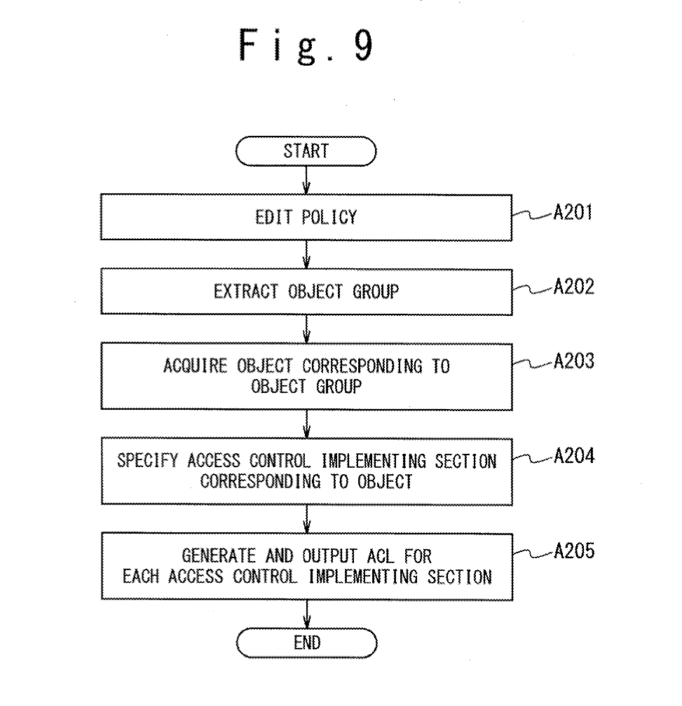

The operation in the policy interpreting process will be described below in detail with reference to FIG. 9.

### (1) Step A201

At first, the policy interpreting section 102 obtains the policy supplied from the policy editing section 101. For example, the policy interpreting section 102 obtains the policy shown in FIG. 8.

### (2) Step A202

Next, the policy interpreting section 102 takes out the object groups from the policy. For example, the policy interpreting section 102 takes out the object groups of “General Affairs Department File” and “General Affairs Department VM” described in the policy shown in FIG. 8.

### (3) Step A203

Next, the policy interpreting section 102 requests a list of objects corresponding to each of the object groups, to the system configuration managing section 200, and obtains the list of objects from the system configuration managing section 200. For example, the system configuration managing section 200 refers to the relation between an object group and objects as shown in FIG. 5 and returns a list of objects corresponding to the object group. For example, the system configuration managing section 200 returns the objects of “vm://vmm05.domain.jp/soumu01.domain.jp” and “vm://vmm05.domain.jp.soumu02.domain.jp” that correspond to the object group of “General Affairs Department VM”. It should be noted that “*” is a special character (a wild card) implying “any character” and matches with any character string except “/”.

### (4) Step A204

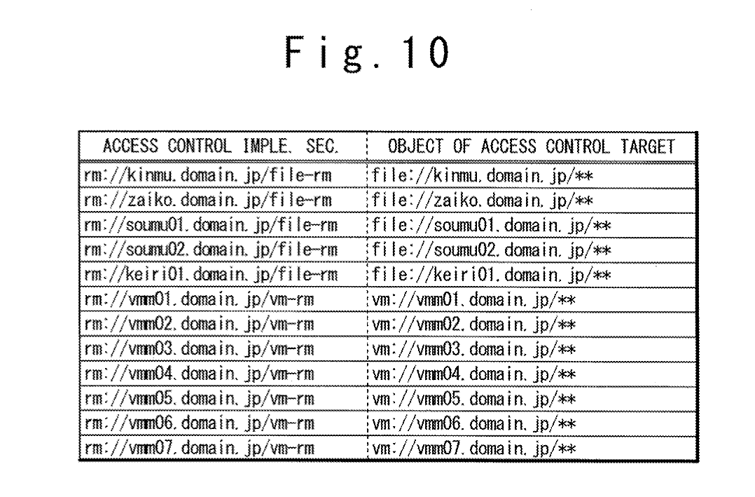

Next, the policy interpreting section 102 requests data associated with the access control implementing sections 300-i (i=1 to n) corresponding to the objects, to the system configuration managing section 200 and obtains the data associated with the access control implementing sections 300-i (i=1 to n) from the system configuration managing section 200. For example, the system configuration managing section 200 refers to the relation between an object and an access control implementing section, as shown in FIG. 10 and returns the data associated with the access control implementing sections 300-i (i=1 to n). For example, the policy interpreting section 102 returns the access control implementing section of “rm://vmm05.domain.jp/vm-rm” corresponding to “vm://vmm05.domain.jp/**”, as the access control implementing section corresponding to the object of “vm://vmm05.domain.jp/soumu01.domain.jp” and “vm://vmm05.domain.jp/soumu02.domain.jp”.

### (5) Step A205

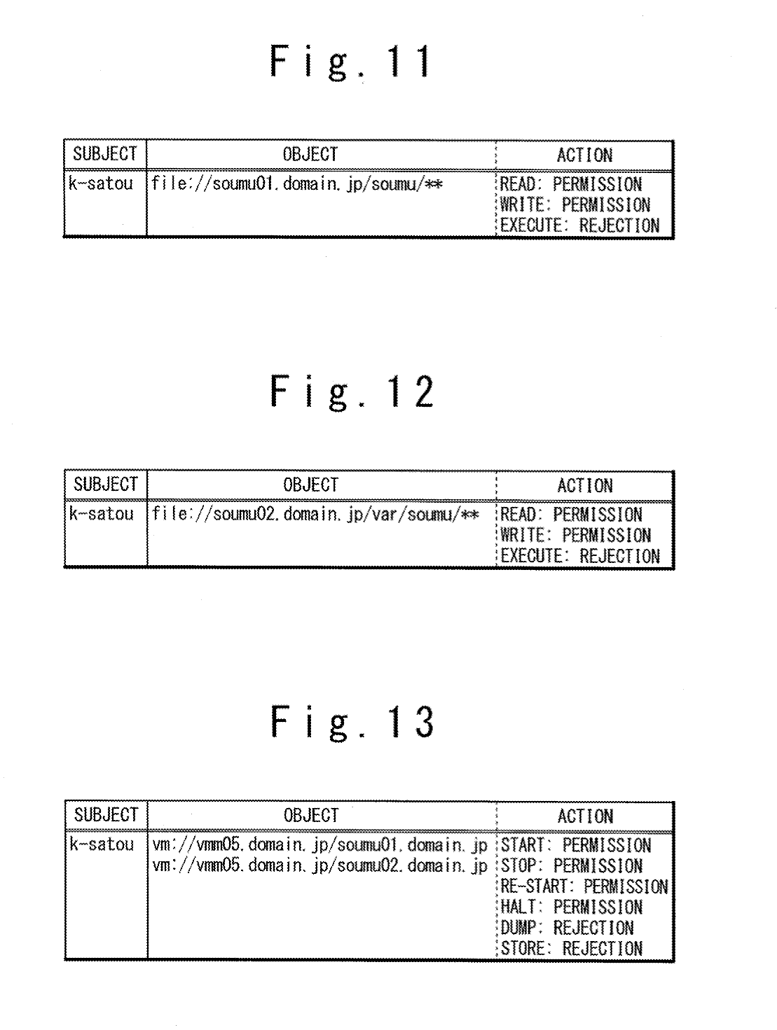

Next, the policy interpreting section 102 generates an ACL for each corresponding access control implementing, section 300-i (i=1 to n) and outputs the generated ACL to the format converting section 103. For example, the policy interpreting section 102 generates the ACL by using the subject of the policy as a subject of the ACL, using as an object of the ACL, an object corresponding to the same access control implementing section 300-i (i=1 to n) in the object group of the policy, and using the action of the policy as an action of the ACL. Thus, the ACL is generated for each access control implementing section 300-i (i=1 to n) corresponding to the object. For example, the policy interpreting section 102 generates the ACL for each access control implementing section 300-i (i=1 to n) as shown in FIG. 11 to FIG. 13. For example, the ACL corresponding to the access control implementing section of “rm://vmm05.domain.jp/vm-rm” is as shown in FIG. 13.

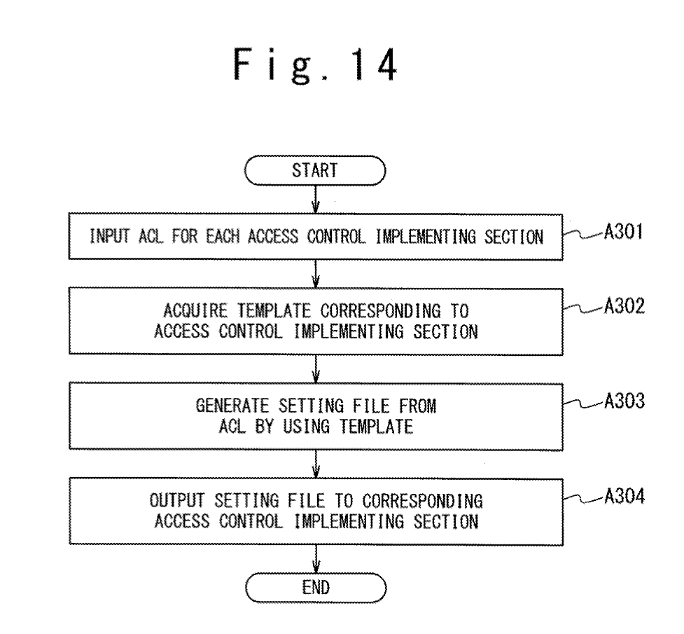

The operation in the format converting process will be described below in detail with reference to FIG. 14.

### (1) Step A301

At first, the format converting section 103 obtains the ACL for each access control implementing section 300-i (i=1 to n) supplied from the policy interpreting section 102. For example, the format converting section 103 obtains the ACL shown in FIG. 13.

### (2) Step A302

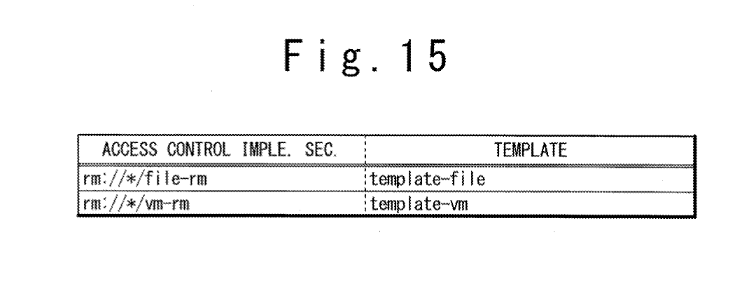

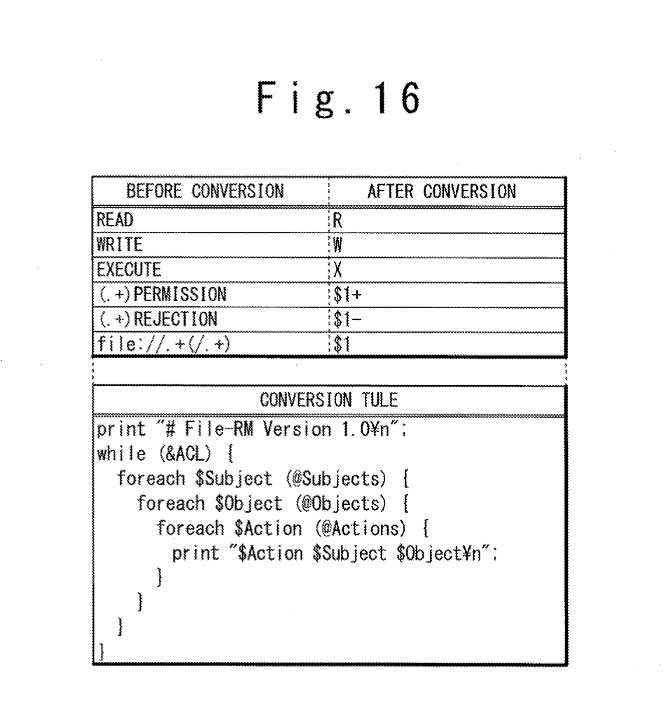

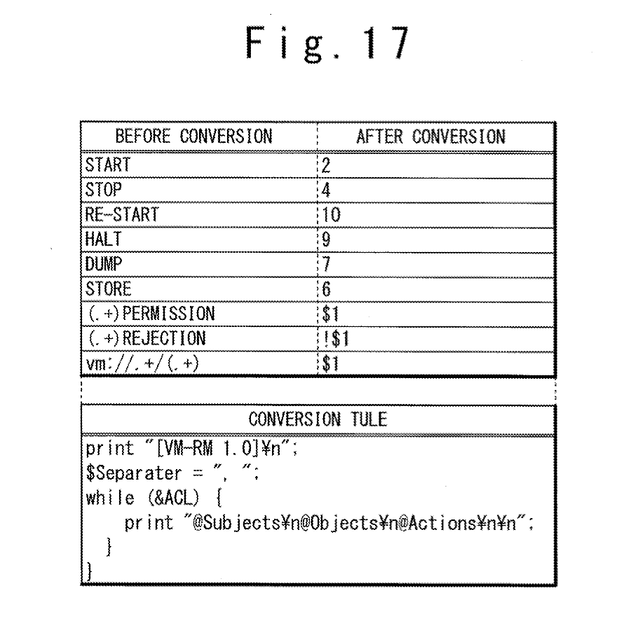

Next, the format converting section 103 requests a template corresponding to the access control implementing section 300-i (i=1 to n), to the format managing section 104 and obtains the template from the format managing section 104. For example, the format managing section 104 refers to a relation between the access control implementing section and a template, as shown in FIG. 15, and returns the template shown in FIG. 16 or FIG. 17 corresponding to the access control implementing section 300-i (i=1 to n). For example, as the template corresponding to the access control implementing section of “rm://vmm05.domain.jp/vm-rm”, the format managing section 104 returns the template shown in FIG. 17.

### (3) Step A303

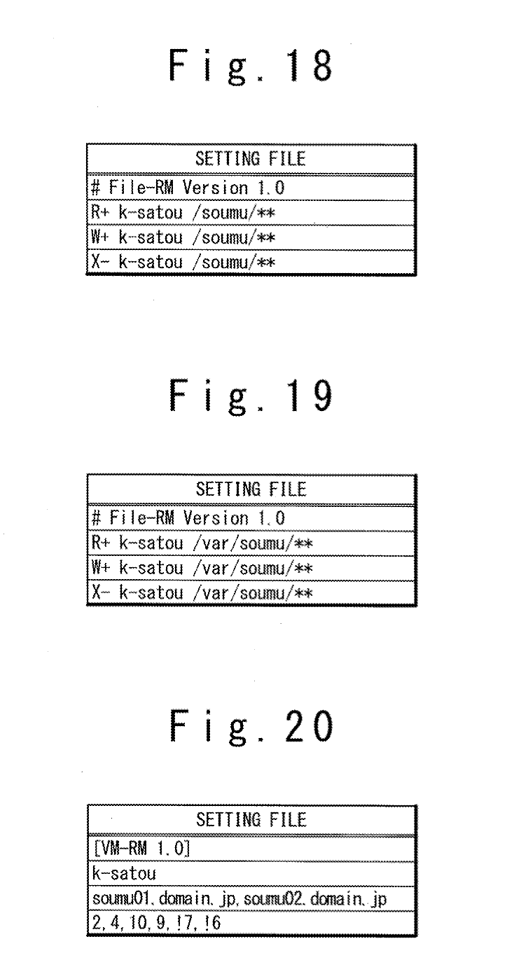

Next, the format converting section 103 generates a setting file for each access control implementing section 300-i (i=1 to n) by using the ACL for each access control implementing section 300-i (i=1 to n) and the template corresponding to the access control implementing section 300-i (i=1 to n). For example, the format converting section 103 generates the setting file for each access control implementing section 300-i (i=1 to n), as shown in FIG. 18, by using the ACL shown in FIG. 11 and the template shown in FIG. 16. Also, the format converting section 103 uses the ACL shown in FIG. 12 and the template shown in FIG. 16 and generates the setting file for each access control implementing section 300-i (i=1 to n) shown in FIG. 19. Also, the format converting section 103 uses the ACL shown in FIG. 13 and the template shown in FIG. 17 and generates the setting file for each access control implementing section 300-i (i=1 to n) shown in FIG. 20.

### (4) Step A304

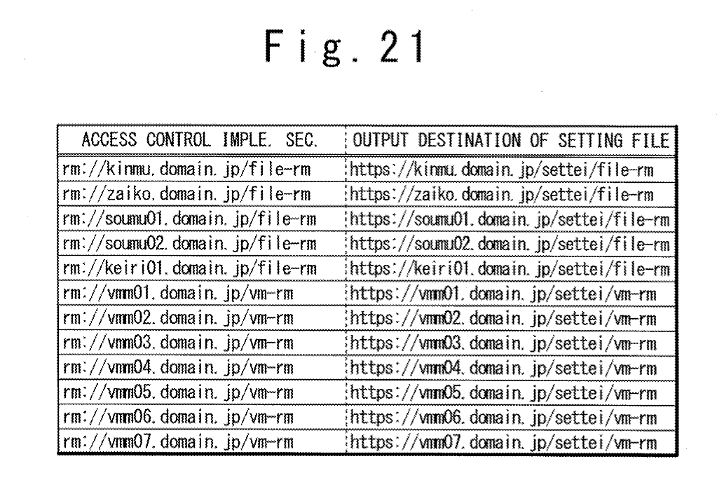

Next, the format converting section 103 requests data associated with an output destination of the setting file corresponding to the access control implementing section 300-i (i=1 to n), to the system configuration managing section 200, and obtains the data associated with the output destination of the setting file from the system configuration managing section 200 and then outputs the setting file to the output destination. For example, the system configuration managing section 200 refers to the relation between an access control implementing section and an output destination of the setting file of the access control implementing section, as shown in FIG. 21, and returns the data associated with the output destination of the setting file corresponding to the access control implementing section 300-i (i=1 to n). For example, the system configuration managing section 200 returns the output destination of “https://vmm05.domain.jp/settei/vm-rm” of the setting file corresponding to the access control implementing section of “rm://vmm05.domain.jp/vm-rm”.

The features of the present invention will be described below.

In the present invention, an access control list is generated from the access control policy that describes a set of an object group and actions at least.

In the present invention, a table that indicates a relation between the object group and one or more objects corresponding to the object group and a table that indicates a relation between the object and the access control implementing section to control the access to the object are stored in the system configuration managing section 200.

Also, in the present invention, a table that indicates a relation between the access control implementing section and a format template of a setting file of the access control implementing section, and the template are stored in the format managing section.

Also, in the present invention, before the access control list is generated from the access control policy, the system configuration managing section is referred, and an access control list different for each access control implementing section can be generated from a same access control policy, in a plurality of access control implementing sections.

Moreover, in the present invention, before the setting file of the access control implementing section is generated from the access control list, the format managing section is referred, and a setting file having a format different for each access control implementing section can be generated from the access control list described in the format that does not depend on a type of the access control implementing section.

In the present invention, a table indicating a relation between an object and an action usable the object is stored in the system configuration managing section, and when the access control policy is described, the system configuration managing section is referred, and a describable object group and a describable action corresponding to the object linked to the object group can be provided.

In the present invention, a table for specifying an distribution destination of a setting file of an access control implementing section has been stored in the system configuration managing section, and the table is referred in accordance with an access control implementing section of a setting target, and a setting file is outputted to a distribution destination different for each access control implementing section.

As mentioned above, in the access control system, the access control method and the access control program of the present invention, when objects in which the usable actions are different and access control implementing sections of many types that are different depending on the object are connected simultaneously, processes of generating access control lists to be applied to the access control implementing sections in formats corresponding to the access control implementing sections, and outputting them to the access control implementing sections are collectively executed in accordance with an access control policy.

In the access control method according to the present invention, when the access control policy is described in accordance with a relation between an object group and an object, a relation between the object and an object type and a relation between the object type and an action, a describable object group and data associated with an action corresponding to the object group are provided. An access control list different for each access control implementing section is generated from a same access control policy based on a relation between the object and the access control implementing section, for a plurality of access control implementing sections. A setting file having a format different for each access control implementing section is generated from an access control list described in a format that does not depend on a type of the access control implementing section, based on a relation between the access control implementing section and a format template of the setting file that describes the content of the access control list. The setting file is outputted based on a relation between the access control implementing section and a distribution destination of the setting file.

The policy editing section provides an editing section for the access control policy to the user. In such a case, an action that can be used in the selected object can be provided.

The policy interpreting section generates access control lists for a plurality of objects from an access control policy. In such a case, the access control list different for each access control implementing section of a set destination can be generated.

The format converting section generates the setting file for the access control implementing section from an access control list. In such a case, a format of the setting file is different for each type of the access control implementing section. Accordingly, the setting file having a format different for each access control implementing section can be generated by managing the template of the format by the format managing section and providing to the format converting section.

According to the present invention, the access control list is generated from the access control policy and is applied to a field to be set. In particular, the present invention can generate and apply the setting files of proper formats describing the access control lists of different proper contents to the access control implementing sections of many types from the same policy for objects of a plurality of types corresponding to different actions simultaneously.

As mentioned above, the embodiment of the present invention has been detailed. However, the present invention is not limited to the above-mentioned embodiments. Then, a modification in a range without departing from the scope of the present invention is also included in the present invention.

It should be noted that this application claims priorities on convention based on Japanese Patent Application Nos. 2008-060231 and 2008-238663, and the disclosures of the Japanese Patent Applications are incorporated herein by reference.

1. An access control system comprising:
a plurality of access control implementing sections configured to control accesses to objects;
a system configuration managing section configured to store data associated with a relation between an object group and objects, a relation between an object and actions, a relation between an object and an access control implementing section, and a relation between an access control implementing section and an installation location of a setting file of said access control implementing section, and retrieve the data associated with a requested relation to output a search result; and
a policy engine configured to refer to said system configuration managing section to generate an access control policy describing a data of a set of said object group and said actions, and generate an access control list, which is different for every access control implementing section, from said access control policy for said plurality of access control implementing sections.

2. The access control system according to claim 1, wherein said policy engine comprises:
a format template of said setting file of said access control implementing section; and
a format template correspondence table indicating a relation between an access control implementing section and an format template, and
wherein said policy engine refers to said format template correspondence table to generate said setting file of a format different for every access control implementing section, from said access control list described in a format which does not depend on a type of said access control implementing section.

3. The access control system according to claim 2, wherein said policy engine refers to said format template correspondence table to output said setting file to the installation location different for every access control implementing section, based on said access control implementing section as a setting target, for said plurality of access control implementing sections.

4. The access control system according to claim 3, wherein said system configuration managing section comprises:
an object group correspondence table indicating the relation between the object group and the objects corresponding to said object group;
an access control correspondence table indicating the relation between the object and the access control implementing section of controlling access to the object; and
an action correspondence table indicating the relation between said object and said action available to the object, and
wherein when a user inputs contents of said access control policy, said policy engine refers to said system configuration managing section and provides data associated with describable object group and describable actions corresponding to said objects linked to said describable object group, to the user.

5. The access control system according to claim 4, wherein said policy engine comprises:
a policy editing section configured to retrieve said object group and said actions corresponding to said object group from said system configuration managing section and provide a UI (User Interface) to the user to edit said access control policy;
a policy interpreting section configured to acquire said access control policy from said policy editing section, and retrieve said object corresponding to said object group and said access control implementing section corresponding to said object from said system configuration managing section to generate said access control list different for every said access control implementing section, for said plurality of access control implementing sections;
a format managing section configured to store the format template of each of said plurality of access control implementing sections and output the format template corresponding to the required access control implementing section; and
a format converting section configured to acquire said access control lists, which are different for every access control implementing section, from said policy interpreting section, retrieve the format template corresponding to said access control implementing section from said format managing section to generate the setting file for every access control implementing section, and retrieve data associated with the installation location of said setting file for every said access control implementing section from said system configuration managing section to distribute the setting file every said access control implementing section to the installation location.

6. An access control method comprising:
controlling accesses to objects by a plurality of access control implementing sections;
storing data associated with a relation between an object group and objects, a relation between said object and actions, a relation between an object and an access control implementing section, and a relation between an access control implementing section and an installation location of a setting file of said access control implementing section, and retrieving the data associated with a requested relation to output a search result; and
referring to said system configuration managing section to generate an access control policy describing a data of a set of said object group and said actions, and generating an access control list, which is different for every said access control implementing section, from said access control policy for said plurality of access control implementing sections.

7. The access control method according to claim 6, further comprising:
holding a format template of said setting file of said access control implementing section and a format template correspondence table indicating a relation between an access control implementing section and an format template; and
referring to said format template correspondence table to generate said setting file of a format different for every access control implementing section, from said access control list described in a format which does not depend on a type of said access control implementing section.

8. The access control method according to claim 7, further comprising:
referring to said format template correspondence table to distribute said setting file to the installation location different for every said access control implementing section, based on said access control implementing section as a setting target, for said plurality of access control implementing sections.

9. The access control method according to claim 8, further comprising:
holding an object group correspondence table indicating the relation between said object group and said objects corresponding to said object group;
holding an access control correspondence table indicating the relation between said object and said access control implementing section of controlling access to said object;
holding an action correspondence table indicating the relation between said object and said action available to said object; and
referring to said system configuration managing section to provide data associated with describable object groups and describable actions corresponding to said objects linked to said describable object groups, to a user, when the user inputs contents of said access control policy.

10. The access control method according to claim 9, further comprising:
retrieving said object group and said actions corresponding to said object group from said system configuration managing section and providing a UI (User Interface) to the user to edit said access control policy;
acquiring said access control policy from said policy editing section, and retrieving said object corresponding to said object group and said access control implementing section corresponding to said object from said system configuration managing section to generate said access control list different for every said access control implementing section, for said plurality of access control implementing sections;
holding the format template of each of said plurality of access control implementing sections; and
acquiring said access control lists, which are different for every access control implementing section, from said policy interpreting section, retrieving the format template corresponding to said access control implementing section from said format managing section to generate the setting file for every access control implementing section, retrieving data associated with the installation location of said setting file for every said access control implementing section from said system configuration managing section, and distributing the setting file every said access control implementing section to said installation location.

11. A computer-readable recording tangible medium in which a computer-executable access control program code is stored to realize an access control method which comprises:
controlling accesses to objects by a plurality of access control implementing sections;
storing data associated with a relation between an object group and objects, a relation between said object and actions, a relation between an object and an access control implementing section, and a relation between an access control implementing section and an installation location of a setting file of said access control implementing section, and retrieving the data associated with a requested relation to output a search result; and
referring to said system configuration managing section to generate an access control policy describing a data of a set of said object group and said actions, and generating an access control list, which is different for every said access control implementing section, from said access control policy for said plurality of access control implementing sections.

12. The computer-readable storage tangible medium according to claim 11, wherein said access control method further comprises:
holding a format template of said setting file of said access control implementing section and a format template correspondence table indicating a relation between an access control implementing section and an format template; and
referring to said format template correspondence table to generate said setting file of a format different for every access control implementing section, from said access control list described in a format which does not depend on a type of said access control implementing section.

13. The computer-readable storage tangible medium according to claim 12, wherein said access control method further comprises:
referring to said format template correspondence table to distribute said setting file to the installation location different for every said access control implementing section, based on said access control implementing section as a setting target, for said plurality of access control implementing sections.

14. The computer-readable storage tangible medium according to claim 13, wherein said access control method further comprises:
holding an object group correspondence table indicating the relation between said object group and said objects corresponding to said object group;
holding an access control correspondence table indicating the relation between said object and said access control implementing section of controlling access to said object;
holding an action correspondence table indicating the relation between said object and said action available to said object; and
referring to said system configuration managing section to provide data associated with describable object groups and describable actions corresponding to said objects linked to said describable object groups, to a user, when the user inputs contents of said access control policy.

15. The computer-readable storage tangible medium according to claim 14, wherein said access control method further comprises:
retrieving said object group and said actions corresponding to said object group from said system configuration managing section and providing a UI (User Interface) to the user to edit said access control policy;
acquiring said access control policy from said policy editing section, and retrieving said object corresponding to said object group and said access control implementing section corresponding to said object from said system configuration managing section to generate said access control list different for every said access control implementing section, for said plurality of access control implementing sections;
holding the format template of each of said plurality of access control implementing sections; and
acquiring said access control lists, which are different for every access control implementing section, from said policy interpreting section, retrieving the format template corresponding to said access control implementing section from said format managing section to generate the setting file for every access control implementing section, retrieving data associated with the installation location of said setting file for every said access control implementing section from said system configuration managing section, and distributing the setting file every said access control implementing section to said installation location.
